(19) United States
(12) Patent Application Publication
(10) Pub. No.: US 2013/0213680 A1
(43) Pub. Date: Aug. 22, 2013

(54) POWER TOOL HAVING VARIABLE SPEED DEVICE

(71) Applicant: Ting-Kuang Chen, Keelung (TW)

(72) Inventor: Ting-Kuang Chen, Keelung (TW)

(73) Assignee: TRINITY PRECISION TECHNOLOGY CO., LTD, Miao-Li Hsien (TW)

(21) Appl. No.: 13/526,269

(22) Filed: Jun. 18, 2012

(30) Foreign Application Priority Data
Feb. 16, 2012 (TW) 101202852

(51) Int. Cl. B25F 5/00

(52) U.S. Cl. 173/47

(57) ABSTRACT

A power tool includes a variable speed device which can be set in an auto mode or a manual mode. The power tool does not need the user to set the speed when it is operated at the auto mode. The power tool is reset to be the high-speed mode when it is activated. The speed is reduced along with the working load so as to output high torque, maintain the best working efficiency and protect the power tool under the operative status. The power tool can be set to the manual mode so as to work in a single type of function.

### BACKGROUND OF THE INVENTION

1. Field of the Invention

The present invention relates generally to a power tool, and more particularly, to a power tool with a variable speed device which allows the user to change the speeds by manual way or by automatic way.

2. The Prior Arts

The conventional power tool, such as a power drill, usually could be operated in variable speeds. However, before the operation, the users have to manually set up the speeds of the power tools that are suitable for the works. If the users do not have sufficient experience, they do not know how to choose a suitable speed for the work. The power tool in not worked in a proper speed and therefore the work cannot be done properly. Sometimes, the power tools are damaged due to improper operation.

### SUMMARY OF THE INVENTION

A primary objective of the present invention is to provide a power tool having a variable speed device that can be set at a manual mode or an auto mode to complete different tasks and overcomes the shortcomings of the conventional variable speed devices. The shortcomings of the conventional variable speed devices include that the inexperienced users are unable to set up proper speeds and the power tools would be damaged under improper working speeds.

The characteristics of the power tool having a variable speed device according to the present invention is that operating speeds can be set at a manual mode or an auto mode. When setting up the power tool under the auto mode, the user does not need to set up the speed of operation and the power tool can be reset to the high-speed status when the power tool is activated. The speed of operation is automatically reduced to increase the output torque when the load increases. Thus, the power tool according to the present invention can be in the best working efficiency. Moreover, the power tool is protected from damaged and the damages due to working under improper speeds are avoided. Furthermore, the power tool can be set at the manual mode which sets the variable speed device at a fixed speed so as to repeatedly operate the power tool by the single function.

A power tool having a variable speed device according to the present invention includes an output unit having an output shaft. A tubular member has an interior space and a plurality of slots is defined axially in the inner periphery thereof The tubular member is connected to the output unit. A variable speed gear set is located in the tubular member and has an output end, a first inner gear, a second inner gear and a disk located from the first end to the second end of the variable speed gear set. The output end is connected to the output shaft. The first inner gear has a plurality of first protrusions on the second end thereof and the second inner gear has a plurality of second protrusions on the outside thereof The disk has a plurality of third protrusions on the second end thereof A locking member is connected to the outside of the tubular member and movable axially relative to the tubular member. The locking member has a plurality of pressing pins which extend toward the first end and the second end of the locking member. The locking member further has a plurality of hooks extending toward the second end thereof and the hooks are engaged with the slots. The pressing pins each has a first end thereof connected with a spring which has the first end thereof contacting with the output unit. A speed switch ring is connected to the second end of the tubular member and has a plurality of inclined surfaces on the first end thereof A plurality of fourth protrusions and a plurality of toothed portions are located on the second end of the speed switch ring. The second ends of the pressing pins of the locking member are in contact with the inclined surfaces. A function switch ring is connected to the second end of the speed switch ring. A movable inner gear is connected to the speed switch ring and the function switch ring. An annular groove is defined in the outside of the movable inner gear which has a plurality of inner teeth defined in the inner periphery thereof A plurality of fifth protrusions is located on the first end of the movable inner gear and a plurality of sixth protrusions is located on the second end of the movable inner gear. A wire is movably located in the annular groove of the movable inner gear. An inner gear is connected to the inner periphery of the movable inner gear and the inner gear has outer toothed portion defined in the outside thereof and inner toothed portion defined in the inner periphery thereof A transmission disk has a transmission gear on the first end thereof and a plurality of planet gears is located on the second end thereof The planet gears are connected to the inner periphery of the movable inner gear and engaged with the inner teeth of the movable inner gear and the outer toothed portion of the inner gear. The transmission gear is engaged with the variable speed gear set. An end cap is connected to the second end of the movable inner gear and has a plurality of protrusions on the outer periphery thereof An inclined groove is defined in the outside of the end cap and the wire is movably engaged with the inclined groove. A plurality of gears is pivotably connected to the end cap and protrudes beyond the inner periphery of the end cap. The gears are engaged with the inner teeth of the movable inner gear and the outer toothed portion of the inner gear. When the end cap is rotated in a first direction or a second direction manually, the wire is moved toward the first end or the second end thereof so as to control the engagement between the sixth protrusions of the movable inner gear and the seventh protrusions of the end cap. An auto switch is located in the tubular member and connected with the wire so as to control the wire to move toward the first end or the second end, and control movement of the hooks of the locking member to engage with the first protrusions, the second protrusions or the third protrusions of the variable speed gear set according to working load.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a power tool having a variable speed device in accordance with the present invention;

FIG. 2 is a partially exploded view showing the power tool in FIG. 1 of the present invention;

FIG. 3 is an exploded view showing the variable speed device according to the present invention;

FIGS. 4A and 4B are two different perspective views showing a speed switch ring of the variable speed device according to the present invention;

FIGS. 5A and 5B are two different perspective views showing an end cap of the variable speed device according to the present invention;

FIGS. 6A and 6B are two different perspective views showing a function switch ring of the variable speed device according to the present invention;

FIG. 7 is a perspective view showing the switch device of the variable speed device according to the present invention;

FIG. 8 shows that the variable speed device according to the present invention outputs low speed and high torque in an auto mode;

FIG. 9 shows that a locking member moves toward a second end when the working load increases gradually and the variable speed device is in auto mode;

FIG. 10 shows that hooks of the locking member are engaged with second protrusions of a second inner gear so that the second inner gear cannot rotate, while the variable speed device is in auto mode;

FIG. 11 shows that sixth protrusions of a movable inner gear are engaged with seventh protrusions of the end cap, so that the movable inner gear and the inner gear are fixed and cannot rotate, while the variable speed device is in a manual mode;

FIG. 12 shows that fifth protrusions of the movable inner gear are engaged with fourth protrusions of the speed switch ring, and the movable inner gear drives the speed switch ring to rotate simultaneously, while the variable speed device is in auto mode; and

FIG. 13 shows that switch gears of the auto switch are engaged with the toothed portions of the speed switch ring.

### DETAILED DESCRIPTION OF THE PREFERRED EMBODIMENT

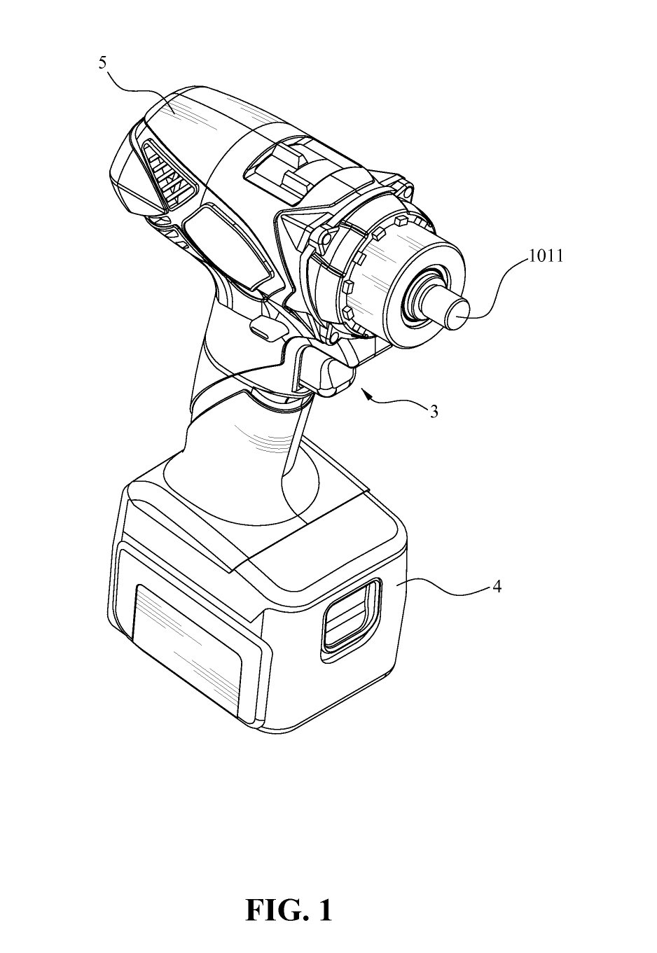

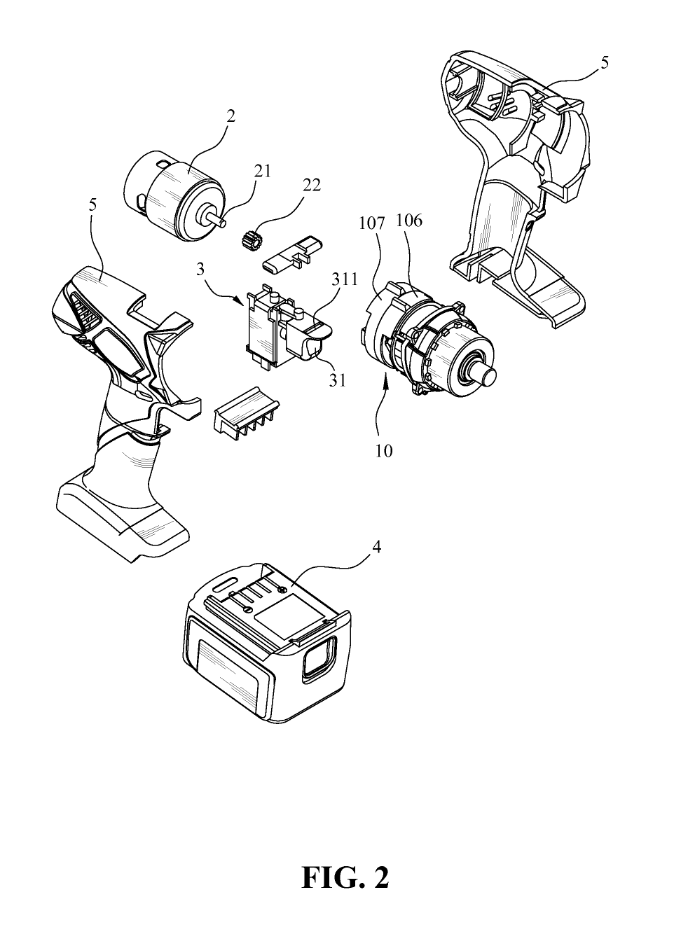

With reference to the drawings and in particular to FIGS. 1 and 2, a power tool comprises a casing 5 in which a variable speed device 10, a motor 2 and a switch device 3 are received. A battery pack 4 is connected to the lower end of the casing 5 so as to provide power to the motor 2. The switch device 3 comprises a trigger 31 which has a hole 311 so as to control the activation of the motor 2. A driving shaft 21 of the motor 2 is connected to a motor gear 22 which is engaged with a gear system of the variable speed device 10. The variable speed device 10 comprises a speed switch ring 106 to control the output speed of an output shaft 1011. The variable speed device 10 has a function switch ring 107 for switching the operation modes of the power tool between an auto mode and a manual mode.

The power tool according to the present invention has a first end and a second end. The first end means the end that is close to the tool bit and the second end is the end opposite to the first end. Thus, in the specification, the first and second ends are defined as mentioned above.

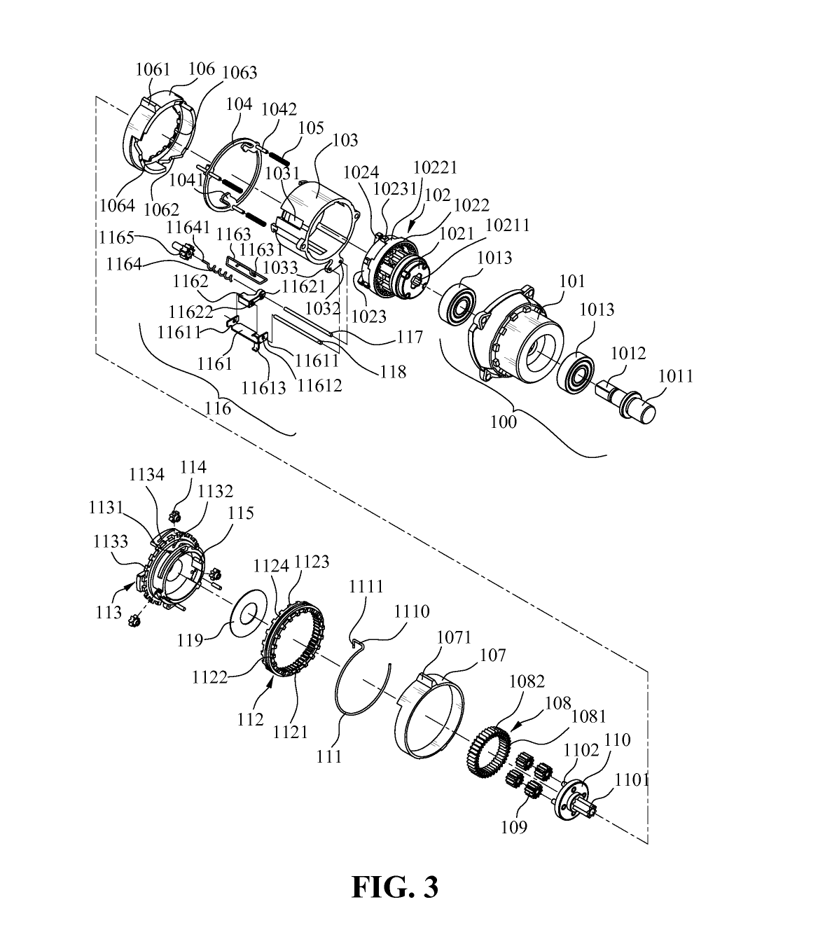

As shown in FIG. 3, the variable speed device 10 according to an embodiment of the present invention comprises an output unit 100, a variable speed gear set 102, a tubular member 103, a locking member 104, a speed switch ring 106, a transmission disk 110, an inner gear 108, a function switch ring 107, a wire 111, a movable inner gear 112 and an end cap 113. The output unit 100 includes a top casing 101 which has two bearings 1013 and the output shaft 1011 is cooperated with the bearings 1013. The first end of the output shaft 1011 is assembled with the tools, such as a screw-driving bit or a drilling head, and the second end of the output shaft 1011 has a polygonal shaft 1012. The first end of the output shaft 1011 extends out of the first end of the top casing 101.

As shown in FIG. 3, the tubular member 103 has an interior space and a plurality of slots 1031 defined axially in the outer periphery thereof The tubular member 103 has a lug located on the outside of the first end and a first hole 1032 and a second hole 1033 are defined through the lug. Bolts are used to extend through the first and second holes 1032, 1033 to fix the first end of the tubular member 103 to the second end of the top casing 101 so as to connect the tubular member 103 with the output unit 100.

As shown in FIG. 3, the variable speed gear set 102 is located in the interior space of the tubular member 103. The variable speed gear set 102 according to the preferred embodiment has an output end 1021, a first inner gear 1022, a second inner gear 1023 and a disk 1024 disposed from the first end to the second end thereof The output end 1021 has a polygonal hole 10211 corresponding to the polygonal shaft 1012 of the output shaft 1011. Thus, after the polygonal shaft 1012 of the output shaft 1011 is engaged with the polygonal hole 10211 of the variable speed gear set 102, the output end 1021 is able to simultaneously rotate the output shaft 1011. The first inner gear 1022 has a plurality of first protrusions 10221 disposed on the second end thereof and the second inner gear 1023 has a plurality of second protrusions 10231 disposed on the outside thereof The disk 1024 has a plurality of third protrusions 10241 disposed on the second end thereof The output end 1021, the first inner gear 1022, the second inner gear 1023 and the disk 1024 form a gear assembly which is known and will not described in detail.

As shown in FIG. 3, the locking member 104 according the preferred embodiment is shaped in a ring. An inner diameter of the locking member 104 is slightly larger than an outer diameter of the tubular member 103 so that the locking member 104 is connected to the outside of the tubular member 103 and movable axially relative to the tubular member 103. The locking member 104 has a plurality of holes along the periphery thereof and each hole is connected with a pressing pin 1042 whose two ends respectively extend toward the first end and the second end of the locking member 104. The first end of each pressing pin 1042 is cooperated with a spring 105 and the second end of each pressing pin 1042 has a hook 1041 extending toward the second end thereof When the locking member 104 is mounted to the tubular member 103, the hooks 1041 are movably engaged with the slots 1031 of the tubular member 103, and the springs 105 each has its first end contacting with the second end of the top casing 101 so that the locking member 104 is capable of moving axially relative to the tubular member 103, but cannot rotate relative to the tubular member 103.

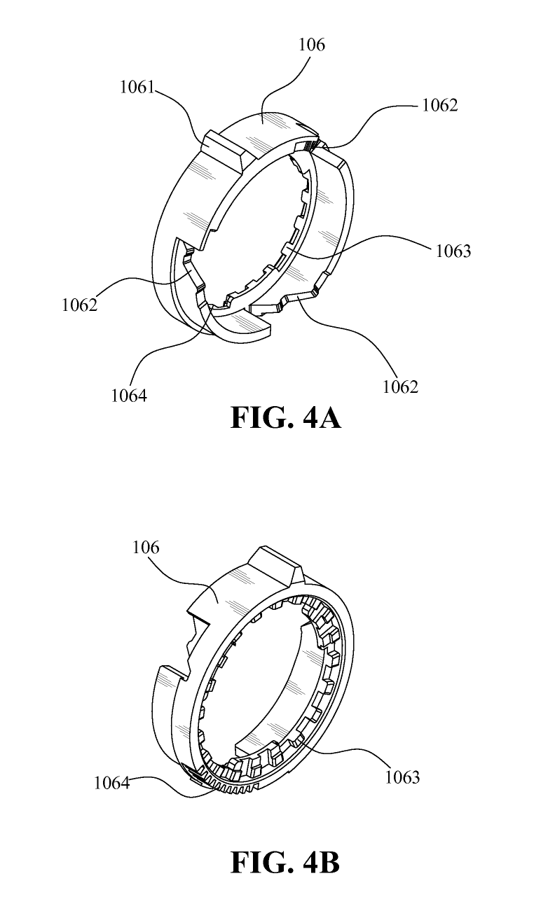

The speed switch ring 106 according to the preferred embodiment is movably mounted to the outside of the tubular member 103. As shown in FIG. 4A, the speed switch ring 106 includes a plurality of inclined surfaces 1062 disposed on the first end thereof and the inclined surfaces 1062 are located corresponding to the pressing pins 1042 of the locking member 104. As shown in FIG. 4B, a plurality of fourth protrusions 1063 are located on the second end of the speed switch ring 106 and a plurality of toothed portions 1064 are located on a part of the outer periphery of the second end of the speed switch ring 106. The speed switch ring 106 has at least one speed plate 1061 at the outside thereof When the speed switch ring 106 is mounted to the tubular member 103, the second ends of the pressing pins 1042 of the locking member 104 are respectively in contact with the inclined surfaces 1062. When the speed switch ring 106 rotates in the first direction, the inclined surfaces 1062 push the pressing pins 1042 of the locking member 104 and move the locking member 104 toward the first end. When the speed switch ring 106 rotates in the second direction, the inclined surfaces 1062 are cooperated with the elastic forces of the springs 105 to drive the locking member 104 toward the second end.

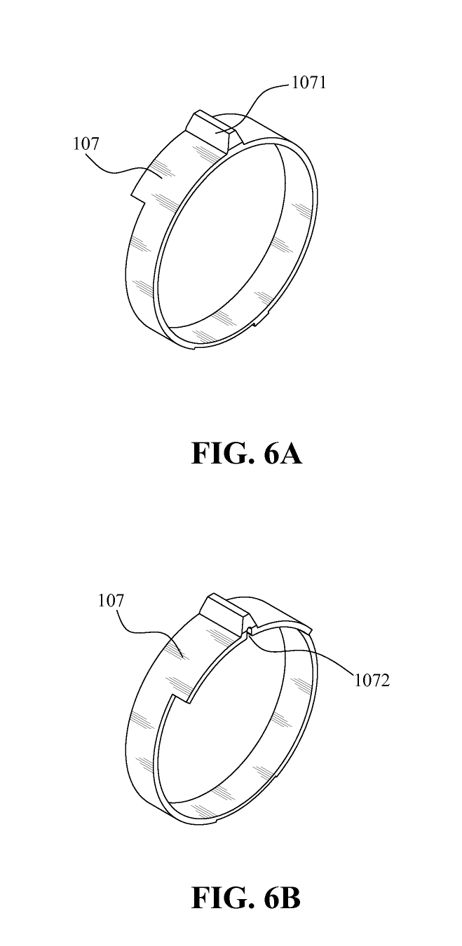

As shown in FIGS. 6A and 6B, the function switch ring 107 according to the preferred embodiment has a function plate 1071 disposed on the outside thereof and a groove 1072 is defined axially in the inner periphery of the function switch ring 107 and located corresponding to the function plate 1071. The function plate 1071 is connected to the second end of the speed switch ring 106.

As shown in FIG. 3, the movable inner gear 112 according the preferred embodiment has an annular groove 1124 defined in the outside thereof. The movable inner gear 112 has a plurality of fifth protrusions 1122 on the first end thereof and a plurality of sixth protrusions 1123 on the second end thereof. A plurality of inner teeth 1121 are defined in the inner periphery of the movable inner gear 112. According to the preferred embodiment, the C-shaped wire 111 is a metallic wire and bent to include a transverse section 1110 and an upright section 1111. The C-shaped wire 111 is engaged with the annular groove 1124 of the movable inner gear 112 and the transverse section 1110 is engaged with the groove 1072 of the function switch ring 107. Thus, the movable inner gear 112 is received in the function switch ring 107. When the function switch ring 107 is rotated, the wire 111 is movable in the annular groove 1124. After the movable inner gear 112 and the wire 111 are connected to the function switch ring 107, the function switch ring 107 is connected to the second end of the speed switch ring 106. Then the connected speed switch ring 106 and the function switch ring 107 are connected to the transmission disk 110. The transmission disk 110 has a transmission gear 1101 disposed on the first end thereof and a plurality of pins 1102 are connected to the second end of the transmission disk 110. A plurality of planet gears 109 are mounted to the pins 1102, respectively. The transmission gear 1101 is engaged with the gears in the variable speed gear set 102 from the second end of the variable speed gear set 102. The inner gear 108 is then connected to the transmission disk 110. The inner gear 108 includes a plurality of inner toothed portions 1081 defined in the inner periphery thereof and a plurality of outer toothed portions 1082 defined in the outside thereof When the inner gear 108 is connected to the transmission disk 110, the inner toothed portions 1081 are engaged with the planet gears 109 and the outer toothed portions 1082 are engaged with the inner teeth 1121 of the movable inner gear 112.

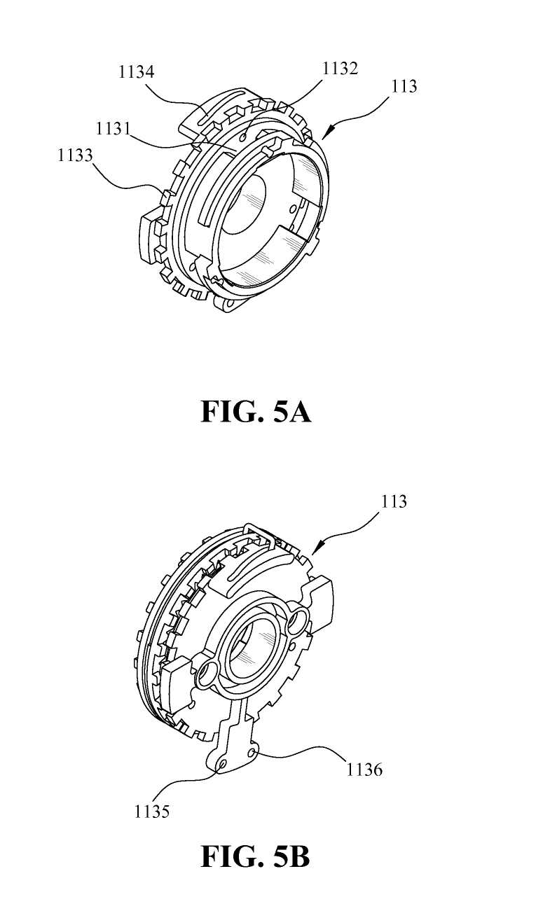

As shown in FIGS. 3, 5A and 5B, the end cap 113 is connected to the second end of the movable inner gear 112 and separates the planet gears 109 and the movable inner gear 108 by the washer 119 at the inside of the end cap 113 so that the planet gears 109 and the movable inner gear 108 are not overly scrub the inside of the end cap 113. The end cap 113 has a plurality of seventh protrusions 1133 on the outer periphery thereof and an inclined groove 1134 is defined in the outside of the end cap 113. The upright section 1111 of the wire 111 is movably engaged with the inclined groove 1134. A plurality of recesses 1131 are defined in the wall of the end cap 113 and each recess 1131 has an axial hole 1132 defined in a vertical face thereof A plurality of pins 115 extend through gears 114 and are pivotably connected to the axial holes 1132 so that the gear 114 extends beyond the inner diameter of the end cap 113. Therefore, the gears 114 are engaged with the inner teeth 1121 of the movable inner gear 112 and the outer toothed portion 1082 of the inner gear 108. The end cap 113 has a wall extending from the lower end thereof and the wall has a third hole 1135 and a fourth hole 1136.

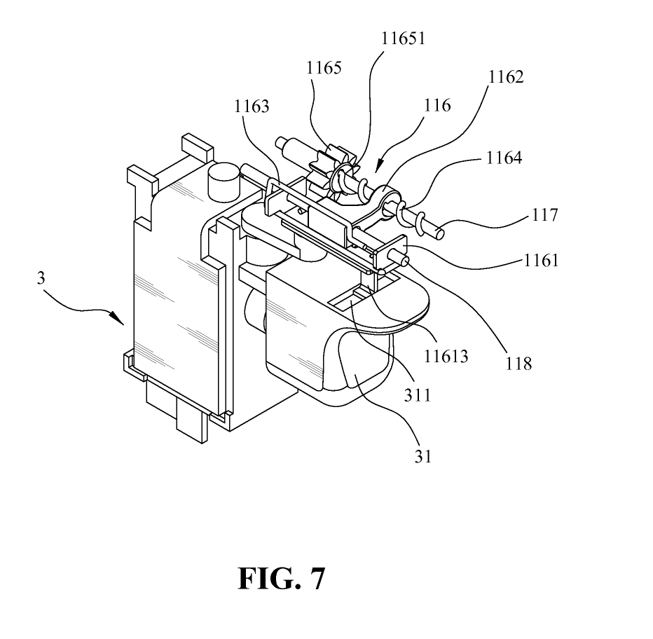

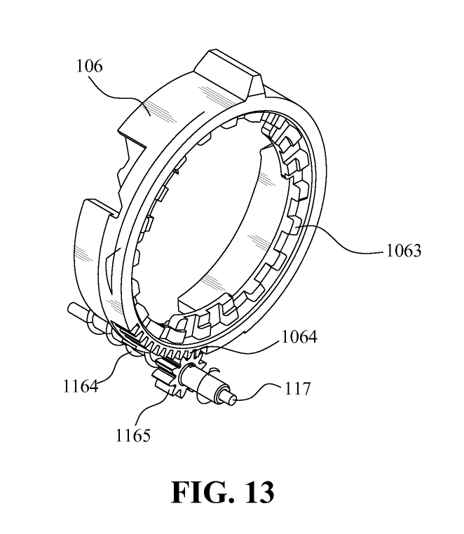

As shown in FIG. 3, an auto switch 116 according to the preferred embodiment includes a connection member 1161, a block 1162 having inner teeth 11621 and a hole 11622, a worm rod 1164, a lever 1163, a first pin 117, a second pin 118 and a switch gear 1165. The connection member 1161 has two extensions on two opposite ends thereof and each extension has a hole 11612. Four notches 11611 are respectively located at the four corners of the connection member 1161 so that the two notches 11611 on two sides of the connection member 1161 are located on a straight line. A curved plate 11613 extends downward from the lower end of the connection member 1161. The lever 1163 is a metallic rod which is bent to form a hook 11631. The lever 1163 is connected to the connection member 1161 and restricted by the notches 11611 of the connection member 1161. The worm rod 1164 is threadedly engaged with the inner teeth 11621 of the block 1162. The worm rod 1164 has a rotation rod 11641 at an end thereof The rotation rod 11641 extends through the keyway 11651 of the switch gear 1165. The switch gear 1165 is engaged with the toothed portion 1064 of the speed switch ring 106 as shown in FIG. 13. The first pin 117 extends through the worm rod 1164 and the switch gear 1165, and the two ends of the first pin 117 respectively extend through the first hole 1032 of the tubular member 103 and the third hole 1135 of the end cap 113. The second pin 118 extends through the hole 11622 of the block 1162 and the hole 11612 of the connection member 1161. The two ends of the second pin 118 respectively extend through the second hole 1033 of the tubular member 103 and the fourth hole 1136 of the end cap 113. The curved plate 11613 of the connection member 1161 is engaged with the hole 311 of the trigger 31. When the trigger 31 is pulled to move the connection member 1161, the lever 1163 and the block 1162 simultaneously, the worm rod 1164 and the switch gear 1165 are simultaneously rotated to rotate the speed switch ring 106. The parts of the auto switch 116 are assembled as shown in FIG. 7.

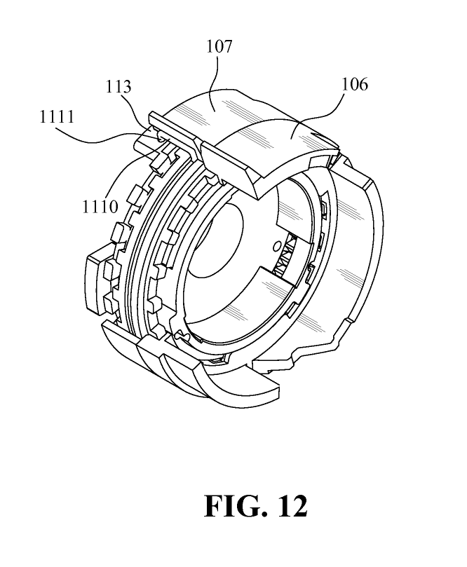

The operation modes of the power tool according to the present invention could be an auto mode or a manual mode. The following descriptions are regarding to the auto mode. As shown in FIG. 12, when the power tool is operated under the auto mode, the user switches the function plate 1071 of the function switch ring 107 toward the first direction to rotate the function switch ring 107 and the wire 111 is simultaneously rotated with the function switch ring 107. The upright section 1111 of the wire 111 is guided by the inclined groove 1134 of the end cap 113 to move toward the first end and drives the movable inner gear 112 toward the first end. The fifth protrusions 1122 on the first end of the movable inner gear 112 are engaged with the fourth protrusion 1063 on the second end of the speed switch ring 106. Therefore, when the movable inner gear 112 is driven to rotate, the speed switch ring 106 is simultaneously rotated with the movable inner gear 112.

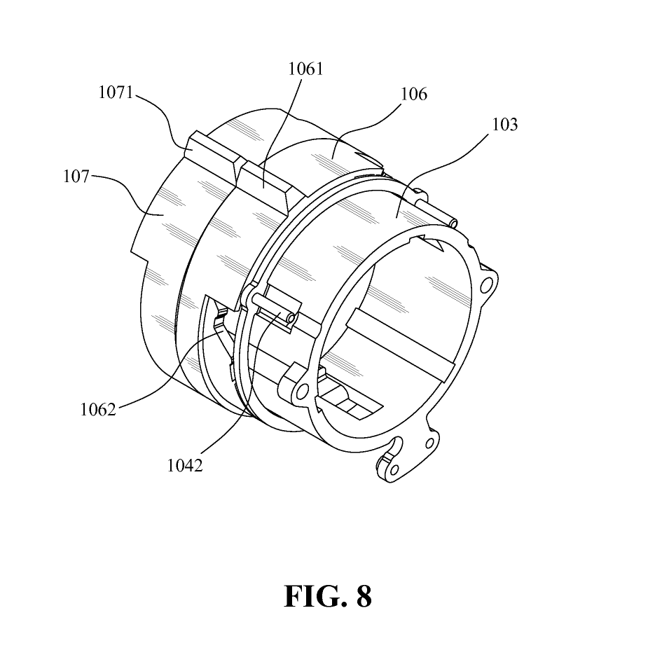

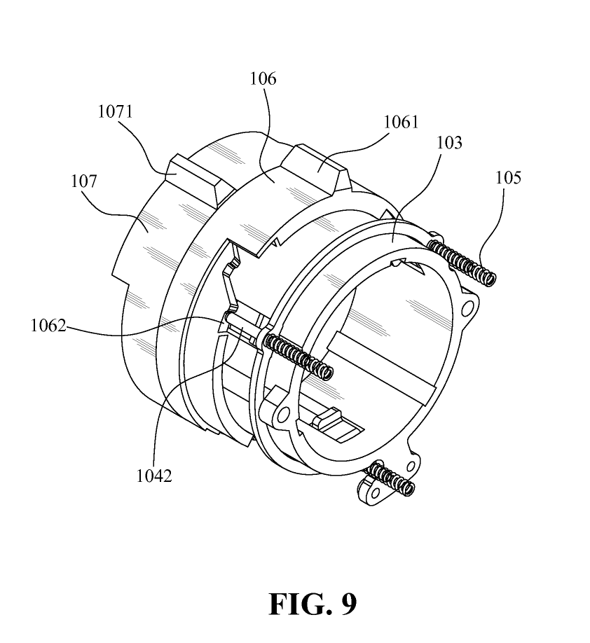

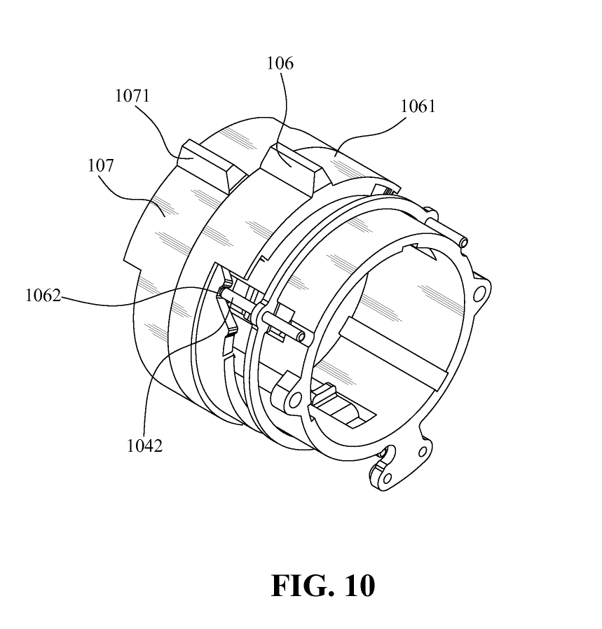

As shown in FIG. 7, when the user presses the trigger 31 on the auto switch 116, the trigger 31 drives the connection member 1161 to move. The lever 1163 connected to the connection member 1161 would pull the block 1162 to move. The inner teeth 11621 of the block 1162 drive the worm rod 1164 to rotate. Thus, the switch gear 1165 is driven to rotate and the switch gear 1165 rotates the speed switch ring 106. The inclined surfaces 1062 on the first end of the speed switch ring 106 move the locking member 104 toward the first end, and the locking member 104 moved with the trigger 31 until the trigger 31 finishes the designated travel thereof. The hooks 1041 of the locking member 104 are engaged with the first protrusions 10221 of the first inner gear 1022 so that the movable inner gear 112 cannot rotate. The variable speed gear set 102 is in the status of high speed and low torque. When the working load gradually increases, the reaction force applied to the inner gear 108 increases. When the reaction force is larger than the elastic force of the springs 105, the inner gear 108 rotates reversely and the outer toothed portions 1082 drive the gear 114 to rotate. Then, the inner gear 108 and the speed switch ring 106 are driven to rotate. Because the inclined surfaces 1062 restrict the movement, the elastic force from the springs 105 pushes the locking member 104 toward the second end as shown in FIG. 9. The hooks 1041 of the locking member 104 switches from the engagement with the first protrusions 10221 of the first inner gear 1022 to the engagement with the second protrusions 10231 of the second inner gear 1023. Therefore, the second inner gear 1023 cannot rotate. The variable speed gear set 102 is in the status of mediate speed and mediate torque to overcome the working load of the output shaft as shown in FIG. 10. When the working load continuously increases, the power tool proceeds the aforementioned steps and the hooks 1041 of the locking member 104 are switched to be engaged with the third protrusions 10241 of the transmission disk 1024 to make the variable speed gear set 102 be in the status of low speed and high torque to finish the tasks as shown in FIG. 8.

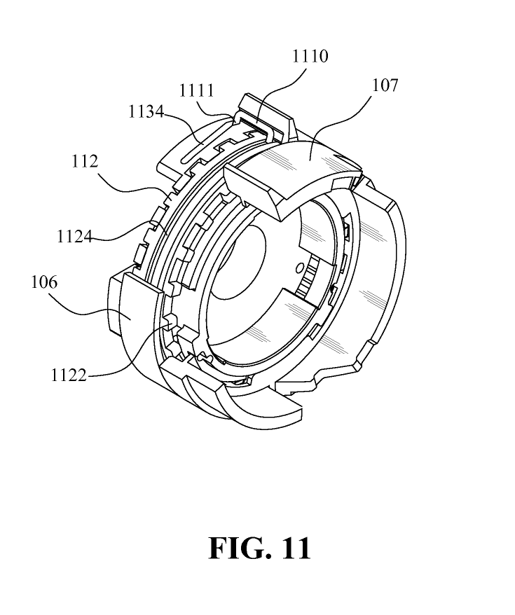

The following descriptions are regarding to the manual mode. As shown in FIG. 11, when the user sets the power tool according to the present invention to be operated in the manual mode, the user shifts the function plate 1071 of the function switch ring 107 toward the second direction to rotate the function switch ring 107 which drives the wire 111 toward the second direction. The upright section 1111 of the wire 111 is guided by the inclined groove 1134 of the end cap 113 to move toward the second end. The movable inner gear 112 is moved toward the second end and the sixth protrusions 1123 on the second end of the movable inner gear 112 are engaged with the seventh protrusions 1133 of the end cap 113 so as to restrict the movable inner gear 112 from rotating. The gear 114 is fixed and cannot rotate. The inner gear 108 that is engaged with the gear 114 is also not able to rotate. Under this status, even if the working load increases, the movable inner gear 112 cannot be rotated so that the variable speed device cannot auto change the speed and this is the manual mode. When the speed needs to be changed, the user needs to manually shift the speed plate 1061 of the speed switch ring 106 to change the speed.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A power tool having a variable speed device, comprising:
an output unit having an output shaft;
a tubular member having an interior space and a plurality of slots defined axially in an inner periphery thereof, the tubular member connected to the output unit;
a variable speed gear set located in the tubular member and having an output end, a first inner gear, a second inner gear and a disk located from a first end to a second end of the power tool, the output end connected to the output shaft, the first inner gear having a plurality of first protrusions disposed on the second end thereof, the second inner gear having a plurality of second protrusions disposed on an outside thereof, the disk having a plurality of third protrusions on a second end thereof;
a locking member connected to an outside of the tubular member and being movable axially relative to the tubular member, the locking member having a plurality of pressing pins which extend toward a first end and a second end of the locking member, the locking member further having a plurality of hooks extending toward the second end thereof, the hooks being engaged with the slots, the pressing pins each having a first end connected with a spring, the spring has a first end contacting with the output unit;
a speed switch ring connected to a second end of the tubular member, and having a plurality of inclined surfaces disposed on a first end thereof, a plurality of fourth protrusions and a plurality of toothed portions located on a second end of the speed switch ring, second ends of the pressing pins of the locking member being respectively contacted with the inclined surfaces;
a function switch ring connected to the second end of the speed switch ring;
a movable inner gear connected to the speed switch ring and the function switch ring, an annular groove defined in an outside of the movable inner gear, the movable inner gear having a plurality of inner teeth defined in an inner periphery thereof, a plurality of fifth protrusions located on a first end of the movable inner gear and a plurality of sixth protrusions located on a second end of the movable inner gear;
a wire movably located in the annular groove of the movable inner gear;
an inner gear connected to an inner periphery of the movable inner gear, the inner gear having outer toothed portion defined in an outside thereof and inner toothed portion defined in an inner periphery thereof;
a transmission disk having a transmission gear disposed on a first end thereof and a plurality of planet gears located on a second end thereof, the planet gears connected to the inner periphery of the movable inner gear and engaged with the inner teeth of the movable inner gear and the outer toothed portions of the inner gear, the transmission gear engaged with the variable speed gear set;
an end cap connected to the second end of the movable inner gear and having a plurality of seventh protrusions disposed on an outer periphery thereof, an inclined groove defined in an outside of the end cap and the wire movably engaged with the inclined groove, a plurality of gears pivotably connected to the end cap and protruding beyond the inner periphery of the end cap, the gears engaged with the inner teeth of the movable inner gear and the outer toothed portions of the inner gear, when the end cap is manually rotated in a first direction or a second direction, the wire is moved toward a first end or a second end thereof so as to control the engagement between the sixth protrusions of the movable inner gear and the seventh protrusions of the end cap; and
an auto switch located in the tubular member and connected with the wire so as to control the wire to move toward the first end or the second end, and control movement of the hooks of the locking member to engage with the first protrusions, the second protrusions or the third protrusions of the variable speed gear set according to working load.

2. The device as claimed in claim 1, wherein the auto switch comprises a connection member having a hole, a block having inner teeth and a hole, a worm rod, a lever, a first pin, a second pin and a switch gear, the lever is connected to the connection member and restricted by the connection member, the worm rod is threadedly engaged with the inner teeth of the block and connected to the switch gear, the first pin extends through the worm rod and the switch gear and is fixed to the tubular member and the end cap, the second pin extends through the hole of the block and the hole of the connection member and is fixed to the tubular member and the end cap, the connection member is connected to a trigger, the trigger is pulled to drive the connection member, the lever and the block so that the worm rod and the switch gear are rotated simultaneously to rotate the speed switch ring.

3. The device as claimed in claim 2, wherein the switch gear has a keyway and the worm rod extends through the keyway and is connected with the switch gear.

4. The device as claimed in claim 1, wherein the wire is a metallic wire and bent to include a transverse section and an upright section, the upright section is movably engaged with the annular groove of the movable inner gear.

5. The device as claimed in claim 2, wherein the trigger has a hole and the connection member has a curved plate which is engaged with the hole of the trigger.

6. The device as claimed in claim 1, wherein the output shaft has a polygonal shaft disposed on a second end thereof and the output end of the variable speed gear set has a polygonal hole with which the polygonal shaft is engaged.
